(19) United States
(12) Patent Application Publication
(10) Pub. No.: US 2006/0232216 A1
(43) Pub. Date: Oct. 19, 2006

(54) Information processing apparatus and luminance adjusting method

(75) Inventor: Makoto Kosaka, Kodaira-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/396,594

(22) Filed: Apr. 4, 2006

(30) Foreign Application Priority Data
Apr. 18, 2005 (JP) 2005-119577

(51) Int. Cl. G09G 3/10

(52) U.S. Cl. 315/169.2; 315/169.3

(57) ABSTRACT

According to one embodiment, an information processing apparatus includes a display unit which includes a light emitting element as a light source, a variable resistance circuit which is connected in series with the light emitting element, a resistance value control unit which changes, when a designated luminance level is lower than a predetermined luminance level, the resistance of the variable resistance circuit from a first resistance to a second resistance larger than the first resistance, and a controller adjusts the value of a driving voltage applied to the light emitting element, in accordance with the designated luminance level.

### CROSS-REFERENCE TO RELATED APPLICATIONS

This application is based upon and claims the benefit of priority from Japanese Patent Application No. 2005-119577, filed Apr. 18, 2005, the entire contents of which are incorporated herein by reference.

### BACKGROUND

1. Field

One embodiment of the invention relates to an information processing apparatus having a display unit with a light emitting element as a light source, and a luminance adjusting method used in the apparatus.

2. Description of the Related Art

In Recent years, a portable apparatus having a display unit such as a liquid crystal display (LCD) with a light emitting element such as a light emitting diode (LED) as a light source has been developed. The LED generates a smaller heat amount, and has a longer life than another light source such as a fluorescent tube. Recently, the luminance efficiency of the LED is also improved.

Jpn. Pat. Appln. KOKAI Publication No. 2002-190392 discloses a technique for keeping the LED backlight luminance of the portable apparatus constant. With this technique, when a battery voltage to be applied as a power supply voltage to the LED decreases, the resistance of a current limit resistor connected to the LED is switched. Accordingly, even when the battery voltage decreases, the LED current does not change, and the backlight luminance can be kept constant.

In order to save power of the portable terminal apparatus, a display luminance must be sufficiently low. In order to further decrease the display luminance, i.e., in order to drive the LED by a smaller LED current, the resistance of the current limit resistor connected to the LED is preferably large. However, when the resistance of the current limit resistor is simply made large, large power is consumed by the current limit resistor upon increasing the display luminance, thus decreasing the light emission efficiency.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the outer appearance of an information processing apparatus according to an embodiment of the present invention;

FIG. 2 is an exemplary block diagram showing a system arrangement of the information processing apparatus shown in FIG. 1;

FIG. 3 is an exemplary block diagram showing a arrangement of an LED driving circuit in the information processing apparatus shown in FIG. 1;

FIG. 4 is an exemplary table showing parameters corresponding to respective display luminance levels used in the first example of luminance control processing executed by the information processing apparatus shown in FIG. 1;

FIG. 5 is an exemplary graph showing the relationship between a pulse width modulation (PWM) signal and display luminance values corresponding to the respective display luminance levels in the first example of the luminance control processing executed by the information processing apparatus shown in FIG. 1;

FIG. 6 is an exemplary table showing parameters corresponding to respective display luminance levels used in the second example of the luminance control processing executed by the information processing apparatus shown in FIG. 1;

FIG. 7 is an exemplary graph showing the relationship between a PWM signal and display luminance values corresponding to the respective display luminance levels in the second example of the luminance control processing executed by the information processing apparatus shown in FIG. 1; and

FIG. 8 is an exemplary flowchart for explaining an example of a luminance control processing procedure executed by the information processing apparatus shown in FIG. 1.

### DETAILED DESCRIPTION

Various embodiments according to the invention will be described hereinafter with reference to the accompanying drawings. In general, according to one embodiment of the invention, an information processing apparatus includes a display unit which includes a light emitting element as a light source, a variable resistance circuit which is connected in series with the light emitting element, a resistance value control unit which changes, when a designated luminance level is lower than a predetermined luminance level, a resistance of the variable resistance circuit from a first resistance to a second resistance larger than the first resistance, and a controller which adjusts a value of a driving voltage applied to the light emitting element, in accordance with the designated luminance level.

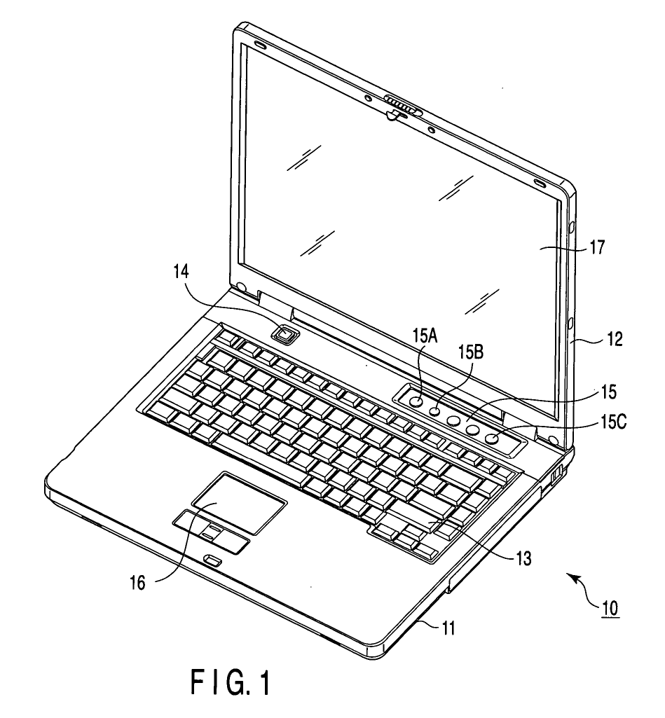

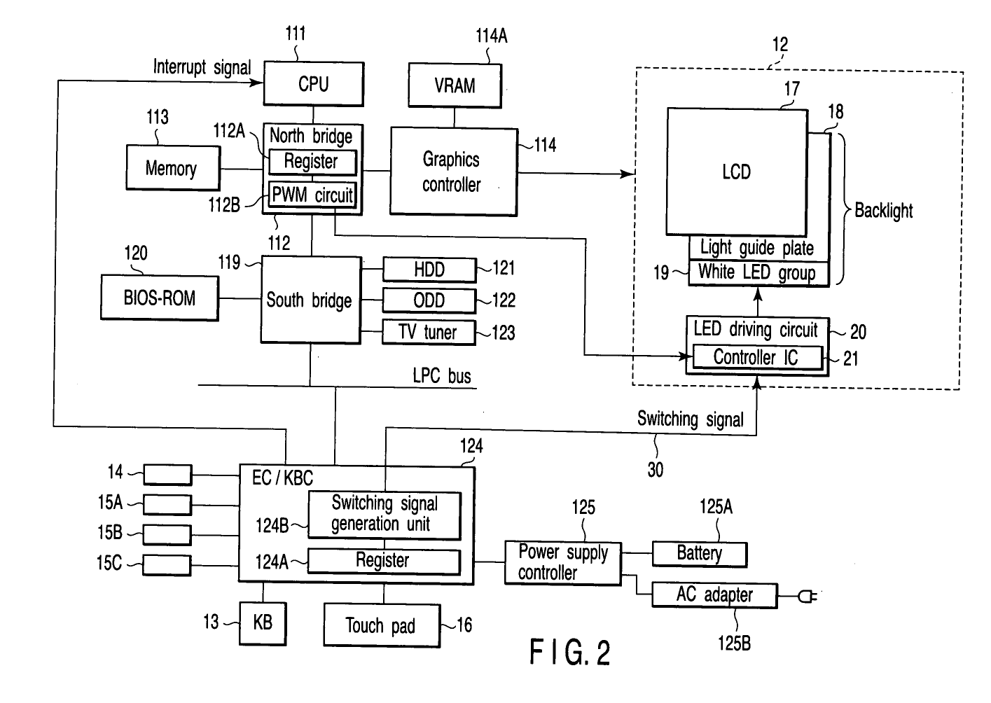

Referring to FIGS. 1 to 2, the arrangement of an information processing apparatus according to an embodiment of the present invention will be described below. This information processing apparatus serves as a battery-drivable and portable notebook personal computer 10.

FIG. 1 is a perspective view showing a state wherein the display unit of the notebook personal computer 10 is open. The computer 10 comprises a computer main body 11 and display unit 12. The display unit 12 incorporates a display device comprising a liquid crystal display (LCD) 17. The display screen of the LCD 17 is located at nearly the center of the display unit 12. The LCD 17 has a transmissive liquid crystal panel. In the display unit 12, a backlight is placed behind the LCD 17. This backlight functions as an illumination device for the display unit 12. The backlight has a light emitting element such as a white light emitting diode (white LED) as a light source. The conventional backlight uses a fluorescent tube such as a cold-cathode tube (cold cathode fluorescent lamp: [CCFL]) as the light source. Upon using the white LED group as the light source for the backlight, it is possible to realize a long life and low power consumption of the backlight.

The display unit 12 is supported by the computer main body 11, and is attached to the computer main body 11 to be pivotal between an open position where the top surface of the computer main body 11 is exposed and a close position where the display unit 12 covers the top surface of the computer main body 11. The computer main body 11 has a thin box-shaped housing. On the top surface of the computer main body 11, a keyboard 13, a power button 14 used to turn on/off the power supply of the computer 10, an input operation panel 15, a touch pad 16, and the like are arranged.

The input operation panel 15 is an input device used to input an event corresponding to a pressed button, and has a plurality of buttons for activating respective functions. The button group includes a TV start button 15A, Digital Versatile Disc (DVD) start button 15B, and luminance control button 15C. When the user presses the TV start button 15A, an application program for executing a TV function is automatically activated. The DVD start button 15B is a button used to play back video content recorded on a DVD. When the user presses the DVD start button 15B, an application program for playing back the video content is automatically activated.

The luminance control button 15C is a button switch used to adjust the display luminance of the LCD 17, i.e., a white LED luminance. When the user presses the luminance control button 15C, an event for instructing to increase (high luminance) or decrease (low luminance) the white LED luminance is generated. The computer 10 has a luminance control function of switching the white LED luminances corresponding to eight levels (display luminance levels 8 to 1). In this embodiment, every time the luminance control button 15C is pressed by the user, the white LED luminance is toggled from the display luminance level 8→7→6, . . . , →2→1→8.

The system arrangement of the computer 10 will be described below with reference to FIG. 2.

As shown in FIG. 2, the computer 10 comprises a central processing unit (CPU) 111, north bridge 112, main memory 113, graphics controller 114, south bridge 119, BIOS-ROM 120, hard disc drive (HDD) 121, optical disc drive (ODD) 122, TV tuner 123, embedded controller/keyboard controller IC (EC/KBC) 124, power supply controller 125, and the like.

The CPU 111 is a processor which controls operations of the computer 10. The CPU 111 executes an operating system (OS) and various application programs which are loaded from the HDD 121 onto the main memory 113.

The CPU 111 also executes a Basic Input-Output System (BIOS) stored in the BIOS-ROM 120. The BIOS is a program for hardware control. This BIOS has a function of controlling the display luminance of the white LED group. The BIOS uses a luminance control table to control the white LED luminance. In the luminance control table, luminance control data corresponding to the respective display luminance levels 8 to 1 are set.

The north bridge 112 is a bridge device that connects the local bus of the CPU 111 and the south bridge 119. The north bridge 112 has a luminance control register 112A and pulse width modulation (PWM) circuit 112B as hardware logics for controlling the display luminance. The luminance control register 112A is an I/O register readable/writable by the CPU 111. The BIOS writes, in the luminance control register 112A, the luminance control data corresponding to a target display luminance level. The PWM circuit 112B generates a PWM signal corresponding to each luminance control data written in the luminance control register 112A. The duty ratio of the PWM signal changes in accordance with the value of the luminance control data. The PWM signal generated by the PWM circuit 112B is sent as the luminance control signal to an LED driving circuit 20 arranged in the display unit 12.

The LED driving circuit 20 is a circuit for driving a white LED group 19. The white LED group 19 is attached to one end side of a light guide plate 18 placed behind the LCD 17. The backlight includes the light guide plate 18 and the white LED group 19. The LED driving circuit 20 has a controller IC 21. The controller IC 21 functions as a boost DC/DC converter. In order to adjust the current value flowing through the white LED group 19, the controller IC 21 adjusts the voltage value of a driving voltage applied to the white LED group 19 in accordance with the PWM signal sent from the PWM circuit 112B.

The north bridge 112 also incorporates a memory controller that executes access control for the main memory 113. The north bridge 112 also has a function of making a communication with the graphics controller 114 via an Accelerated Graphics Port (AGP) bus or the like.

The graphics controller 114 is a display controller which controls the LCD 17 used as the display monitor of the computer 10. The graphics controller 114 has a video memory (VRAM) 114A, and generates a video signal for forming a display image to be displayed on the LCD 17 of the display unit 12, in accordance with the display data written in the video memory 114A by the OS/application program.

The south bridge 119 controls each device on a low pin count (LPC) bus. The south bridge 119 incorporates an integrated drive electronics (IDE) controller which controls the HDD 121 and ODD 122. The south bridge 119 also has a function of controlling the TV tuner 123, and a function of executing access control for the BIOS-ROM 120.

The HDD 121 is a storage device for storing various software and data. In the HDD 121, the above-described operating system and various application systems are stored.

The optical disc drive (ODD) 122 is a drive unit for driving a storage medium such as a DVD and CD in which video contents are stored. The TV tuner 123 is a reception device for externally receiving broadcast program data such as a TV broadcast.

The embedded controller/keyboard controller IC (EC/KBC) 124 is a one-chip microcomputer on which an embedded controller for power supply management, and a keyboard controller that controls the keyboard (KB) 13 and touch pad 16 are integrated. When the user presses the luminance control button 15C, the embedded controller/keyboard controller IC (EC/KBC) 124 generates an interrupt signal such as a system management interrupt (SMI) in order to notify the BIOS that a display luminance switching event is input. The embedded controller/keyboard controller IC (EC/KBC) 124 has a function of turning on/off the power supply of the computer 10 in response to user's operation of the power button 14 in collaboration with the power supply controller 125. The embedded controller/keyboard controller IC (EC/KBC) 124 also includes a register 124A and switching signal generation unit 124B as the hardware logics for controlling the display luminance.

The register 124A is an I/O register readable/writable by the CPU 111. On the basis of control data set in the register 124A by the BIOS, the switching signal generation unit 124B generates a switching signal for changing the resistance of the current limit resistor arranged in the LED driving circuit 20.

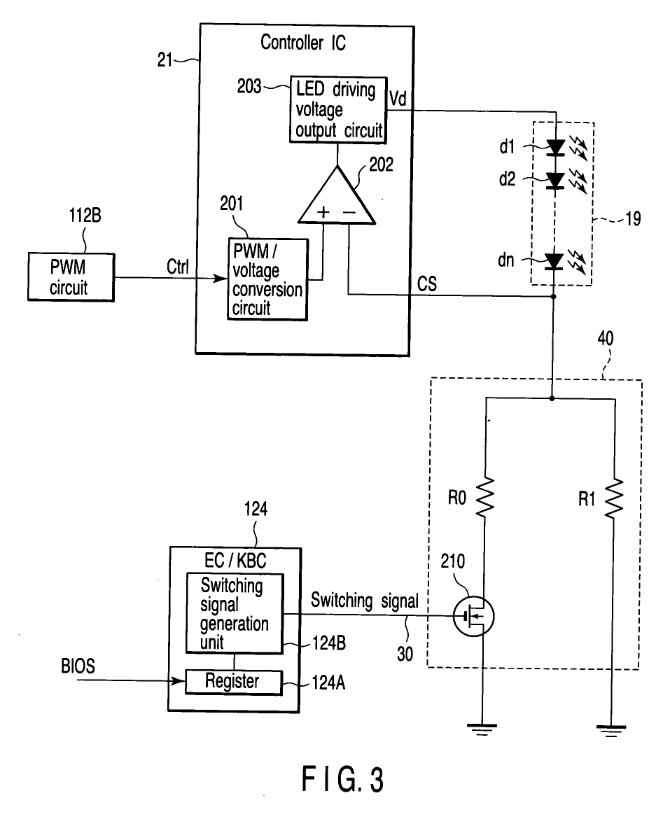

The arrangement of the above-described LED driving circuit 20 will be described next with reference to FIG. 3. The white LED group 19 includes a plurality of white LEDs d1, d2, . . . dn connected in series. A variable resistance circuit 40 is connected in series with the white LED group 19. The variable resistance circuit 40 functions as the current limit resistor.

The controller IC 21 senses the current flowing through the white LED group 19, in accordance with the voltage value at the node between the white LED group 19 and the variable resistance circuit 40. The controller IC 21 adjusts the value of a driving voltage Vd on the basis of the sensed current value and the duty ratio of the PWM signal input as the luminance control signal to the controller IC 21.

The controller IC 21 has a PWM/voltage conversion circuit 201, comparator 202, and LED driving voltage output circuit 203. The PWM/voltage conversion circuit 201 converts, into a voltage value, the duty ratio of the PWM signal input from the PWM circuit 112B via the control terminal (Ctrl). The comparator 202 compares the voltage value input from the PWM/voltage conversion circuit 201 and the voltage value input via an LED current sensing terminal (CS). The LED driving voltage output circuit 203 generates the driving voltage Vd for driving the white LED group 19 in accordance with output from the comparator 202.

The variable resistance circuit 40 includes a resistor R0, transistor 210, resistor R1, and the like. The transistor 210 is a field-effect transistor (FET) which is turned on/off in accordance with a switching signal 30 generated by the switching signal generation unit 124B. The current value flowing through the white LED group 19 is basically determined in accordance with the resistances of the variable resistance circuit 40 and the driving voltage Vd.

When the transistor 210 is turned on, the resistance of the variable resistance circuit 40 is obtained as a combined resistance (first resistance) of a parallel circuit including the resistors R0 and R1. When the transistor 210 is turned off, the resistance of the variable resistance circuit 40 is equal to the resistance of the resistor R1 (second resistance). The second resistance is larger than the first resistance.

The luminance of the white LED group 19 changes in accordance with the current flowing through the LED group 19. That is, when the resistance of the variable resistance circuit 40 is the second resistance, the current flowing through the white LED group 19 becomes smaller than the current obtained when the resistance of the variable resistance circuit 40 is the first resistance. That is, the luminance value of the white LED group 19 decreases.

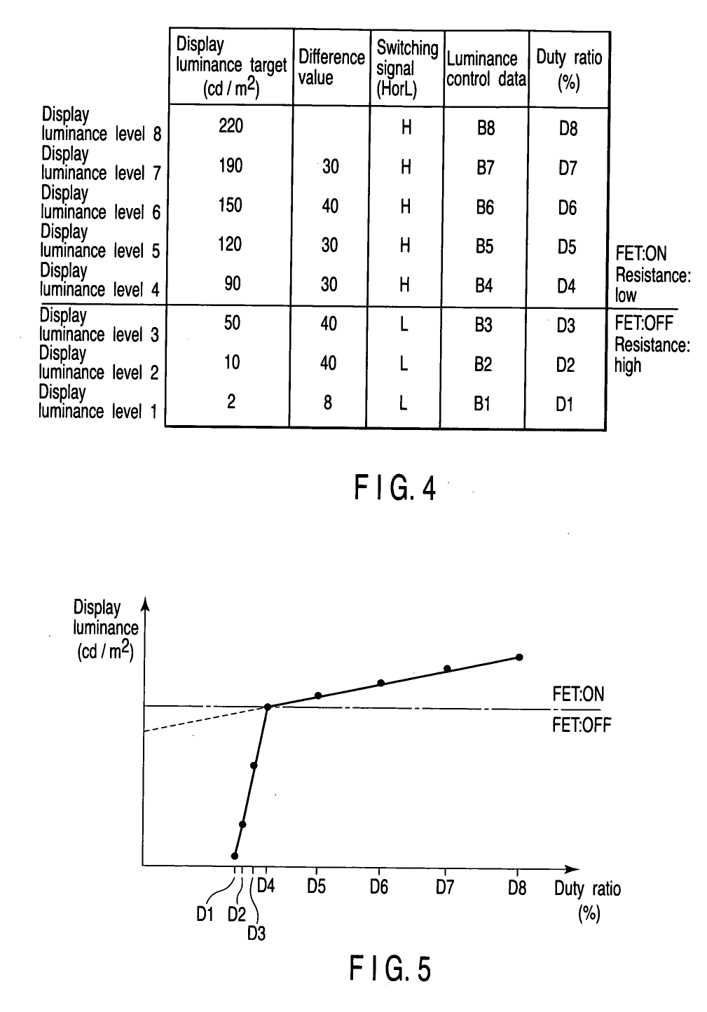

The first example of the luminance control processing of controlling the luminance of the white LED group 19 will be described next with reference to FIGS. 4 and 5. FIG. 4 shows the relationship among display luminance targets (cd/m²), logical levels (high and low) of the switching signal, the luminance control data and duty ratios of the PWM signal, corresponding to the respective display luminance levels 1 to 8.

The display luminance target indicates the luminance value (cd/m²) of the white LED group 19. For example, the maximum value (display luminance level=8) of the display luminance target of the computer 10 is 220 cd/m². When the luminance value of the white LED group 19 is set to 220 cd/m², video data can be brightly and clearly displayed on the LCD 17. The minimum value (display luminance level=1) of the display luminance target of the computer 10 is 2 cd/m². When the luminance value of the white LED group 19 is set to 2 cd/m², the power consumption of the LCD 17 can be sufficiently reduced.

In FIG. 4, a difference value indicates the difference between the luminance value of the display luminance target at a certain display luminance level and that at a next display luminance level. When one of the display luminance levels 8 to 4 is designated as the target display luminance level by user's operation or the like, the switching signal is made high to turn on the transistor 210. On the other hand, when one of the display luminance levels 3 to 1 is designated as the target display luminance level, the switching signal is made low to turn off the transistor 210.

The luminance control data indicates the data value to be set in the register 112A. The luminance control data values are determined in advance in accordance with the respective display luminance target values. For example, the luminance control data contains a binary data of 16 bits. Note that reference symbols B1 to B8 in FIG. 4 virtually denote the luminance control data values corresponding to the respective display luminance levels 1 to 8.

The duty ratio indicates the duty ratio of the PWM signal generated by the PWM circuit 112B. The duty ratios D1 to D8 virtually indicate the duty ratios corresponding to the respective display luminance levels 1 to 8.

One of the display luminance levels 1 to 8 is used as a default display luminance when the computer 10 is powered on. For example, in this embodiment, when the computer 10 is booted, the display luminance level 8 is designated as the default display luminance level. When the computer 10 is booted, the BIOS writes, in the luminance control register 112A, the luminance control data B8 corresponding to the designated display luminance level 8. On the basis of the luminance control data B8 written in the register 112A, the PWM circuit 112B outputs the PWM signal to the controller IC 21.

The BIOS also writes the switching signal control data as high in the register 124A. The switching signal generation unit 124B turns on the transistor 210 on the basis of the high switching signal control data written in the register 124A.

FIG. 5 shows the relationship between the display luminance values and PWM signals, corresponding to the respective display luminance levels 8 to 1. When the transistor 210 is turned on, the display luminances corresponding to the respective display luminance levels 8 to 4 decrease as indicted by a bold solid line. In the case of where the transistor 210 is turned on, the display luminances corresponding to the respective display luminance levels 3 to 1 change as indicated by a dotted line shown in FIG. 5. Accordingly, when the transistor 210 is turned on (switching signal high), the luminance of the white LED group 19 can only decrease to a certain degree.

To cope with this, when the target display luminance level is lower than a reference level, i.e., when the target display luminance level is lower than the display luminance level 4, the resistance of the variable resistance circuit 40 changes from the first resistance to the second resistance. That is, when the target display luminance level is lower than the display luminance level 4, the BIOS sets a switching signal control data as low in the register 124A. On the basis of the low switching signal control data written in the register 124A, the switching signal generation unit 124B turns off the transistor 210. Accordingly, as indicated by the bold line representing the values of D3, D2, and D1 in FIG. 5, the display luminances corresponding to the respective display luminance levels 3 to 1 can sufficiently decrease in comparison with the display luminances when the transistor 210 is on. That is, the adjustment range of the display luminance can become sufficiently broad.

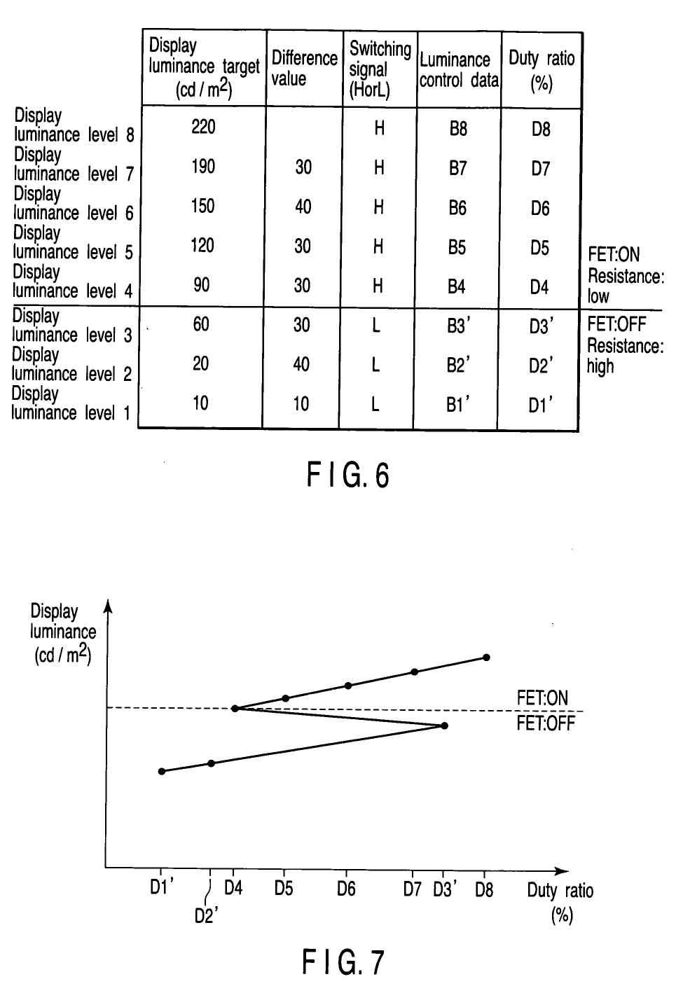

The second example of the luminance control processing of controlling the luminance of the white LED group 19 will be described next with reference to FIGS. 6 and 7. In the luminance control processing, the display luminance of the white LED group 19 preferably changes linearly as much as possible. Hence, in the second example of the luminance control processing, as shown in FIG. 6, the luminance control data B3 to B1 corresponding to the respective display luminance levels 3 to 1 change to the luminance control data B3‘to B1’. That is, the values of the luminance control data B8 to B4 are determined on the basis of the display luminance levels 8 to 4 and the first resistance of the variable resistance circuit 40. The values of the luminance control data B3′ to B1′ are determined on the basis of the display luminance levels 3 to 1 and the second resistance of the variable resistance circuit 40. In this case, the value of the luminance control data B3′ corresponding to the display luminance level 3 is larger than the value of the luminance control data B4 corresponding to the display luminance level 4. Hence, the adjustment range of the display luminance can be sufficiently broad, and the display luminance can linearly decrease as shown in FIG. 7.

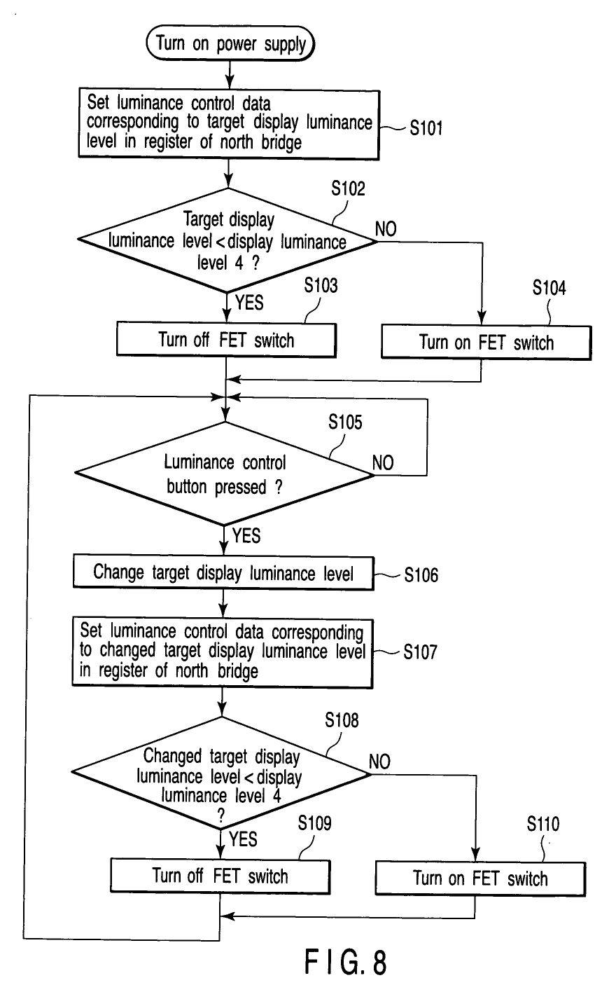

The example of a luminance control processing procedure executed by the BIOS will be described next with reference to the flowchart of FIG. 8. When the computer 10 is powered on, the CPU 111 loads, in the main memory 113, the BIOS stored in the BIOS-ROM 120. The CPU 111 then sets, in the luminance control register 112A of the north bridge 112, the luminance control data which are included in the BIOS loaded in the memory and correspond to the target display luminance levels set in advance (block S101).

The CPU 111 executes processing of determining whether the target display luminance level is lower than the display luminance level 4 (block S102). If the target display luminance level is lower than the display luminance level 4 (YES in block S102), the transistor 210 is turned off (block S103). In block S103, the CPU 111 sets the switching signal control data as low in the register 124A. On the basis of the low signal control data set in the register 124A, the switching signal generation unit 124B makes the switching signal 30 low.

On the other hand, if the target display luminance level is not lower than the display luminance level 4, i.e., if the target display luminance level is equal to or higher than the display luminance level 4 (NO in block S102), the transistor 210 is turned on (block S104). In block S104, the CPU 111 sets the switching signal control data as high in the register 124A. On the basis of the high signal control data set in the register 124A, the switching signal generation unit 124B makes the switching signal 30 high.

When the user presses the luminance control button 15C (YES in block S105), the CPU 111 changes the target display luminance level (block S106). In block S106, the target display luminance level changes to the display luminance level lower by one level than the current display luminance level. The CPU 111 executes processing of determining whether the changed target display luminance level is lower than the display luminance level 4 (block S108). If the changed target display luminance level is lower than the display luminance level 4 (YES in block S108), the transistor 210 is turned off (block S109). On the other hand, if the target display luminance level is not lower than the display luminance level 4, i.e., if the target display luminance level is equal to or higher than the display luminance level 4 (NO in block S108), the transistor 210 is turned on (block S110).

As described above, in this embodiment, only when the target display luminance level is lower than the reference level, the resistance of the variable resistance circuit 40 is changed from the first resistance to the second resistance larger than the first resistance. Hence, the LED current value can sufficiently decrease. The adjustment range of the display luminance can be broadened, and the power consumption of the computer 10 can be reduced. When the display luminance increases, the resistance of the variable resistance circuit 40 returns to the first resistance, thus reducing wasteful power consumption of the variable resistance circuit 40.

Note that in this embodiment, the white LED group 19 includes a plurality of white LEDs. However, the white LED group 19 may include only one white LED depending on the size of the backlight.

In this embodiment, the luminance changes from high to low every time the user presses the luminance control button 15C. However, the luminance may change from low to high.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display unit which includes a light emitting element as a light source;
a variable resistance circuit which is connected in series with the light emitting element;
a resistance value control unit which changes, when a designated luminance level is lower than a predetermined luminance level, a resistance of the variable resistance circuit from a first resistance to a second resistance, a value of the second resistance larger than a value of the first resistance; and
a controller which adjusts a value of a driving voltage applied to the light emitting element, in accordance with the designated luminance level.

2. The information processing apparatus according to claim 1, wherein the resistance value control unit sets, when the designated luminance level is not lower than the predetermined luminance level, the resistance of the variable resistance circuit to the first resistance, and sets, when the designated luminance level is lower than the predetermined luminance level, the resistance of the variable resistance circuit to the second resistance.

3. The information processing apparatus according to claim 1, further comprising:
a controlling unit which controls, when the designated luminance level is not lower than the predetermined luminance level, a value of a luminance control signal based on the designated luminance level and the first resistance, and which controls, when the designated luminance level is lower than the predetermined luminance level, the value of the luminance control signal based on the designated luminance level and the second resistance; and
wherein the controller adjusts the value of the driving voltage applied to the light emitting element, in accordance with the value of the luminance control signal controlled by the controlling unit.

4. The information processing apparatus according to claim 1, wherein the designated luminance level is one of a first luminance level, a second luminance level which is lower than the first luminance level and not less than the predetermined luminance level, a third luminance level which is lower than the predetermined luminance level, and a fourth luminance level which is lower than the third luminance level; and
the information processing apparatus further comprising a changing unit which changes, when the designated luminance level changes from the first luminance level to the second luminance level, a value of a luminance control signal from a first value corresponding to the first luminance level to a second value which corresponds to the second luminance level and is lower than the first value, and which changes, when the designated luminance level changes from the second luminance level to the third luminance level, the value of the luminance control signal from the second value to a third value which corresponds to the third luminance level and is larger than the second value; and
wherein the controller includes a unit which adjusts the value of the driving voltage applied to the light emitting element, in accordance with the value of the luminance control signal changed by the changing unit.

5. The information processing apparatus according to claim 1, further comprising:
a unit which controls a value of a luminance control signal in accordance with the designated luminance level; and
wherein the controller is configured to sense a current value flowing through the light emitting element, in accordance with a voltage value at a node between the light emitting element and the variable resistance circuit, and adjust the value of the driving voltage based on the value of the luminance control signal and the sensed current value.

6. The information processing apparatus according to claim 1, wherein the light emitting element is a white light emitting diode.

7. A luminance adjusting method of adjusting a luminance of a display unit which includes a light emitting element as a light source, a variable resistance circuit which is connected in series with the light emitting element, and a controller which adjusts a value of a driving voltage applied to the light emitting element in accordance with the designated luminance level, comprising:
changing, when a designated luminance level is lower than a predetermined luminance level, a resistance of the variable resistance circuit from a first resistance to a second resistance, a value of the second resistance larger than a value of the first resistance.

8. The luminance adjusting method according to claim 7, wherein changing includes setting, when the designated luminance level is not lower than the predetermined luminance level, the resistance of the variable resistance circuit to the first resistance, and setting, when the designated luminance level is lower than the predetermined luminance level, the resistance of the variable resistance circuit to the second resistance.

9. The luminance adjusting method according to claim 7, further comprising:
controlling, when the designated luminance level is not lower than the predetermined luminance level, a value of a luminance control signal based on the designated luminance level and the first resistance, and controlling, when the designated luminance level is lower than the predetermined luminance level, the value of the luminance control signal based on the designated luminance level and the second resistance; and
wherein the controller adjusts the value of the driving voltage applied to the light emitting element, in accordance with the value of the controlled luminance control signal.

10. The luminance adjusting method according to claim 7, wherein the designated luminance level is one of a first luminance level, a second luminance level which is lower than the first luminance level and not less than the predetermined luminance level, a third luminance level which is lower than the predetermined luminance level, and a fourth luminance level which is lower than the third luminance level; and
the method further comprising changing, when the designated luminance level changes from the first luminance level to the second luminance level, a value of a luminance control signal from a first value corresponding to the first luminance level to a second value corresponding to the second luminance level, and changing, when the designated luminance level changes from the second luminance level to the third luminance level, the value of the luminance control signal from the second value to a third value which corresponds to the third luminance level and is larger than the second value; and
wherein the controller adjusts the value of the driving voltage applied to the light emitting element, in accordance with the value of the changed luminance control signal.

11. The luminance adjusting method according to claim 7, further comprising:
controlling a value of a luminance control signal in accordance with the designated luminance level; and
wherein the controller senses a current value flowing through the light emitting element, in accordance with a voltage value at a node between the light emitting element and the variable resistance circuit, and adjusts the value of the driving voltage based on the value of the luminance control signal and the sensed current value.
